(19) United States
(12) Patent Application Publication
(10) Pub. No.: US 2015/0048604 A1
(43) Pub. Date: Feb. 19, 2015

(54) Rolling-Up Device for Rolling Up a Belt and Safety Belt System

(71) Applicant: Daimler AG, Stuttgart (DE)

(72) Inventors: Christian Burczyk, Stuttgart (DE); Till Heinrich, Stuttgart (DE)

(21) Appl. No.: 14/371,884

(22) PCT Filed: Dec. 14, 2012
(86) PCT No.: PCT/EP2012/005203

§ 371 Date: Jul. 11, 2014

(30) Foreign Application Priority Data
Jan. 13, 2012 (DE) 10 2012 000 488.5

(51) Int. Cl. B60R 22/34; B60R 22/12; B60R 21/18

(52) U.S. Cl. CPC B60R 22/34; B60R 21/18; B60R 22/12
USPC 280/733; 242/376; 297/475

(57) ABSTRACT

A rolling up device for rolling up a belt includes a reel for rolling up a belt around an external surface of the reel rotating around an axis of rotation. The external surface of the reel is tilted or arched at least partially towards the axis of rotation of the reel in the axial direction towards the axis of rotation.

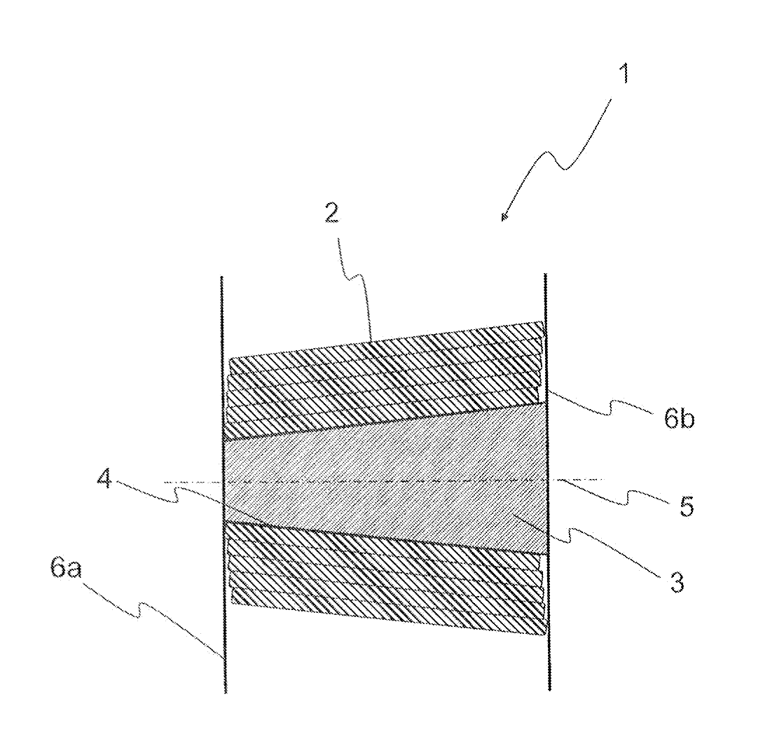

### BACKGROUND AND SUMMARY OF THE INVENTION

Exemplary embodiments of the invention relate to a rolling up device for rolling up a belt and to a safety belt system.

German patent document DE 197 57 373 A1 discloses an arrangement for rolling up a belt having a cylindrical reel, which has an axial recess running parallel to the reel axis on its external surface, as well as having a belt fixed to the reel. A reinforcement element is arranged on the reel and bridges the axial recess. The reel is cylindrically formed.

Exemplary embodiments of the invention are directed to an improved rolling up device compared to prior art for rolling up a belt and an improved safety belt system, comprising such a rolling up device.

The rolling up device according to the invention for rolling up a belt comprises a reel for rolling up a belt around an external surface of a reel rotating around an axis of rotation. The external surface is at least partially tilted or arched towards the axis of rotation of the reel in the axial direction towards the axis of rotation.

The belt is, in particular, suitable to fasten a passenger of a motor vehicle into the motor vehicle in the case of an accident in such a way that loads of the passenger caused by the accident can be reduced by the belt. The rolling up device serves to roll up the unnecessary belt, in particular in the case of an automatic safety belt system in which the length of the belt emitted by the rolling up device adapts automatically to the respective requirements. The respective requirements are, for example, a deposit position, in which the belt is not needed, or different dimensions of the passenger, which for the safety thereof are able to be embraced by the belt.

The reel can also be referred to as a roll, onto which the belt is able to be rolled up, which can also be referred to as able to wind up. For the automatic rolling up of the belt, the reel of the rolling up device is usually loaded with force in such a way that the reel moves in a rotational direction suitable for rolling up the belt, if the tension of the belt is so low that unnecessary belt can be wound up by the reel. When rolling up the belt, the belt is wound up around the external surface of the reel that rotates around its axis of rotation. The axis of rotation is that around which the rotation of the reel occurs or can occur. The axis of rotation can also be present without a structural feature. In one embodiment of the reel, having a structurally formed axis of rotation, the reel comprises, for example, a through-hole running along the axis of rotation, in which a rod runs in such a way that the reel is mounted rotatably around the rod.

The external surface is at least partially tilted or arched towards the axis of rotation of the reel in the axial direction towards the axis of rotation. Due to this tilting or arching of the external surface, how the belt behaves when wound up around the external surface can be influenced in a very simple way, In particular, it can thus be influenced into which region the belt can preferably be wound up around the external surface.

In specific embodiments, the reel is designed to be conical, wedge-shaped or spherical.

In the case of the conical reel, the external surface thereof runs with rotational symmetry around the axis of rotation, wherein the distance of the external surface to the axis of rotation decreases continuously from one side of the axis of rotation to the other side. It is hereby achieved that, during winding up, the belt is wound up around the reel firstly on the side of the external surface, which has the shorter distance to the axis of rotation.

In an alternative embodiment, the reel is designed to be wedge-shaped. In the case of a wedge-shaped reel, two side surfaces of the reel run together at an acute angle. The wedge-shaped reel is not rotationally symmetrical. The wedge-shaped reel causes the belt, during rolling up, to be rolled up around the reel firstly preferably around the region of the external surface, which has a shorter distance to the axis of rotation.

In an alternative embodiment, the reel is designed to be spherical. A spherical reel has an external surface that is arched towards the axis of rotation of the reel in the axial direction towards the axis of rotation. This external surface can therein, for example, be formed to be either concave or convex, wherein the external surface is formed to be rotationally symmetrical in a specific development. In the case of a reel that is designed to be spherical, the external surface thereof has the shortest distance to the axis of rotation in the center of the reel. This causes the belt, during rolling up, to be arranged around the reel, preferably in the center of the reel.

In one embodiment, the rolling up device furthermore comprises at least one boundary wall running laterally to the reel and fundamentally perpendicularly to the axis of rotation. The boundary wall causes, for example, an unintentional rolling-up of the belt laterally to the reel to be prevented. The boundary wall can connected to the reel in one piece or embodied as a separate component. In an embodiment, the rolling up device comprises a boundary wall on both sides of the reel respectively. It can also be influenced by the different embodiments of the reel described above, whether and, if necessary, to what extent the belt wound up on the reel exerts a lateral force on the boundary wall.

A safety belt system according to the invention comprises a belt and a rolling up device described above. The safety belt system corresponds to a usual safety belt system used in motor vehicles for securing passengers, wherein at least one rolling up device of the safety belt system is formed according to one of the embodiments described above. A usual safety belt system is, for example, a so-called three-point safety belt system having automatic wind-up of unnecessary belt.

In one development, the belt of the safety belt system is formed at least partially in multiple layers. An example for a belt formed in multiple layers is a belt that is formed to be tubular, which is consolidated in a flat manner. A further component of the safety belt system can, for example, be applied within the tubular belt, wherein the further component is protected from environmental influences by the belt surrounding it.

In one specific development, the belt itself or an air sack running along the belt is at least partially inflatable. Such a safety belt system is a combination of a safety belt system and an air bag system, whereby the passenger can be better protected. In a conventional embodiment, the tubular belt is, for example, inflated by means of a gas produced by a gas generator, if the gas generator is activated by a control unit in the case of an accident, in order to protect the passenger secured with the safety belt system.

### BRIEF DESCRIPTION OF THE DRAWING FIGURE

One embodiment of the present invention is described in an exemplary way with regard to the drawing.

The sole FIGURE illustrates a cross-section of a belt rolled up around a reel having two lateral boundary walls.

### DETAILED DESCRIPTION

The sole FIGURE illustrates a wedge-shaped reel 3 in cross-section having two lateral boundary walls 6a, 6b and a belt rolled-up around the reel 3. An axis of rotation 5 of the reel is marked in the center. The layers of the belt 2 are illustrated above and below the reel 3. Due to the wedge-shaped reel, the first layer of the belt 2 is taken up first on the side of the external surface 4 of the reel 3 having the shortest distance to the axis of rotation 5. The left boundary wall 6a prevents the belt 2 from being rolled up laterally to the reel 3. In the case of further rolling-up of the belt 2 around the reel 3, an uneven compression of the layers of the belt 2 can lead to some layers of the belt 2 being rolled up closer in the region of the right boundary wall 6b. Therein the right boundary wall 6b can prevent a rolling-up of the belt 2 laterally to the reel 3.

In other words, the invention can be depicted as follows:

The belt roll in the retractor is supported on one of the side walls of the refractor housing in the case of tensile stress. This can lead to a load on a side wall that is so strong that the side wall is deformed. In order to prevent a deformation, costly reinforcements are required.

In order to prevent or at least to reduce a deformation without costly reinforcements, the winding shaft of the retractor is asymmetrical in the winding direction, and thus has, during rolling-up the belt on the retractor, a preferred region for rolling up the belt on the winding shaft. Geometries of the winding shaft are conceivable, for example, having a wedge-shaped design or a conical or spherical design.

Using the solution according to the invention, the lateral loading of the side walls or of the retractor housing can be reduced. Additionally, the belt can be protected in that abrasion of the belt is prevented or reduced in the case of lateral contact, for example with a side wall.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-6. (canceled)

7. A rolling up device for rolling up a vehicle safety belt, comprising:
a reel configured to roll-up the vehicle safety belt around an external surface of the reel rotating around an axis of rotation,
wherein the external surface is at least partially tilted or arched towards the axis of rotation of the reel in the axial direction towards the axis of rotation.

8. The rolling up device of claim 7, wherein the reel is conical, wedge-shaped, or spherical.

9. The rolling up device of claim 7, wherein the rolling up device furthermore comprises:
at least one boundary wall running laterally to the reel and perpendicularly to the axis of rotation.

10. A vehicle safety belt system, comprising:
a vehicle safety belt; and
a rolling up device for rolling up a vehicle safety belt, comprising
a reel configured to roll-up the vehicle safety belt around an external surface of the reel rotating around an axis of rotation,
wherein the external surface is at least partially tilted or arched towards the axis of rotation of the reel in the axial direction towards the axis of rotation.

11. The safety belt system of claim 10, wherein the vehicle safety belt at least partially comprises multiple layers.

12. The safety belt system of claim 10, wherein the vehicle safety belt or an air sack running along the vehicle safety belt is configured to be at least partially inflatable.
